(19) United States
(12) Patent Application Publication
(10) Pub. No.: US 2024/0027209 A1
(43) Pub. Date: Jan. 25, 2024

(54) Method and Device for Determining a Driving Route for a Vehicle Driven in an Automated Manner

(71) Applicant: Bayerische Motoren Werke Aktiengesellschaft, Muenchen (DE)

(72) Inventors: Christian DENICH, Muenchen (DE); Sabrina DENICH, Muenchen (DE); Benjamin QUATTELBAUM, Muenchen (DE)

(21) Appl. No.: 18/037,585

(22) PCT Filed: Oct. 11, 2021
(86) PCT No.: PCT/EP2021/078077

§ 371 Date: May 18, 2023

(30) Foreign Application Priority Data
Dec. 17, 2020 (DE) 10 2020 133 937.2

(51) Int. Cl. G01C 21/34; B60W 60/00

(52) U.S. Cl. CPC G01C 21/3461; G01C 21/3484; B60W 60/0016; B60W 60/0027; B60W 2554/80

(57) ABSTRACT

A device is provided for determining a driving route for a vehicle which has an automated driving mode and a manual driving mode. The device is configured to determine release information relating to the release of the automated driving mode on different road portions of a road network on which the vehicle is travelling. The device is also configured to determine and/or predict availability information relating to the availability of the driver of the vehicle for manually guiding the vehicle longitudinally and/or transversely during a journey from a starting point to a destination point. Furthermore, the device is configured to determine a driving route through the road network from the starting point to the destination point based on the release information and the availability information.

### BACKGROUND AND SUMMARY OF THE INVENTION

The invention relates to a vehicle which is designed to drive autonomously at least partially and/or at least in some sections. In particular, the invention relates to a method and a corresponding device for determining a driving route for a vehicle having an automated driving mode.

A vehicle can have an automated driving mode, in which the longitudinal and/or the lateral control of the vehicle is carried out in a partially or completely automated manner by the vehicle. Furthermore, the vehicle can have a manual driving mode, in which the longitudinal and/or lateral control of the vehicle is carried out partially or completely by the driver of the vehicle. The degree of automation of the vehicle can possibly be variable here in multiple steps between a completely automated driving mode and a completely manual driving mode.

To get from a starting point to a destination point, a driving route can be planned by way of a navigation device of an autonomously driving vehicle. The comfort of a journey from the starting point to the destination point can be dependent on the planned driving route. The present document relates to the technical problem of enabling the determination of the most comfortable possible driving route for a vehicle having an automated driving mode.

The object is achieved by the claimed invention.

According to one aspect, a device for determining a driving route for a (motor) vehicle is described. The vehicle has an automated driving mode, in which the vehicle is longitudinally and/or laterally controlled in an at least partially or completely automated manner (for example according to SAE level 3 or more). Furthermore, the vehicle has a manual driving mode, in which the vehicle is longitudinally and/or laterally controlled at least partially or completely manually by the driver of the vehicle (for example according to SAE level 2 or less).

The device is configured to determine clearance information with respect to the clearance of the automated driving mode on different roadway sections of the roadway network traveled by the vehicle. The device can be configured in particular to determine digital map information with respect to the roadway network traveled by the vehicle. The digital map information can describe the spatial and/or geographic arrangement of the different roadway sections and/or roadway node points of the roadway network. Furthermore, the digital map information can comprise the clearance information for different roadway sections of the roadway network. The clearance information can possibly depend on the current weather conditions and/or the current traffic conditions. It can thus be determined on which one or more roadway sections of the roadway network the use of the automated driving mode is possible (possibly currently). Furthermore, it can be determined on which one or more roadway sections of the roadway network the use of the manual driving mode is required (possibly currently).

The device is furthermore configured to determine and/or predict availability information with respect to the availability of the driver of the vehicle for manual longitudinal and/or lateral control of the vehicle during a journey from a starting point (within the roadway network) to a destination point (within the roadway network), for which a driving route is to be determined. It can be predicted in particular in which one or more upcoming time intervals on the journey along the driving route to be planned the driver will probably be available for the manual longitudinal and/or lateral control of the vehicle or probably will not be available for the manual longitudinal and/or lateral control of the vehicle.

The device can be configured to determine and/or predict the availability information on the basis of one or more of the following data: sensor data with respect to the driver, which are acquired by one or more driver sensors, in particular by one or more interior cameras, of the vehicle; data of an infotainment system of the vehicle (for example with respect to an audio and/or video program, which the driver wishes to hear or see); data from a personal user device (for example smart phone) of the driver; and/or data from a digital calendar of the driver (for example with respect to a planned audio and/or videoconference during the journey along the driving route to be planned). The availability of the driver of the vehicle for manual longitudinal and/or lateral control on the upcoming journey can thus be predicted in a precise manner.

The device can be configured in particular to determine and/or predict availability information which, for a sequence of upcoming time intervals during the journey from the starting point to the destination point, indicates in each case the degree of the availability of the driver of the vehicle for manual longitudinal and/or lateral control of the vehicle in the respective time interval. Alternatively or additionally, the predicted availability information can indicate the desired degree of automation of the vehicle in the respective time interval of the sequence of time intervals. Alternatively or additionally, the predicted availability information can indicate for each sequence of upcoming time intervals whether the driver of the vehicle is available in the respective time interval for operating the vehicle in the manual driving mode or not.

Furthermore, the device is configured, on the basis of the clearance information and on the basis of the availability information (and in consideration of the digital map information), to determine at least one driving route through the roadway network from the starting point to the destination point. At least one driving route can be determined (using a routing algorithm), in which the clearance of the sequence of roadway sections of the driving route matches as well as possible with the predicted availability of the driver for manual longitudinal and/or lateral control of the vehicle on the sequence of time intervals on the journey along the driving route. The comfort for the driver of a vehicle having an automated driving mode can thus be increased.

The device can be configured (in the scope of determining a driving route) to determine for a (possible) driving route a correlation measure of the correlation and/or the correspondence and/or the overlap between one or more roadway sections, in which the automated driving mode has clearance, and one or more time intervals in which the driver is not available to operate the vehicle in the manual driving mode. The driving route can then be determined in such a way that the correlation measure is increased, in particular maximized. A driving route can therefore be determined which has the greatest possible correlation (with respect to time and/or location) between roadway sections which are cleared for the automated driving mode, and time intervals having low availability for manual driving of the driver. The comfort can thus be further increased for the driver of the vehicle.

As already described above, the clearance information for a large number of roadway sections of the roadway network can indicate in each case the possible degree of automation of the vehicle in the respective roadway section. The device can be configured (in the scope of determining a driving route), for a (possible) driving route having a sequence of roadway sections, to determine a correlation measure of the correlation and/or the overlap and/or the correspondence between the possible degrees of automation on the sequence of roadway sections of the driving route and the desired degrees of automation on the sequence of time intervals during the journey from the starting point to the destination point. The driving route can then be determined in such a way that the correlation measure is increased, in particular maximized.

At least one driving route can thus be determined in which the possible degrees of automation of the vehicle on the roadway sections of the planned driving route match as well as possible with the predicted nonavailability of the driver for manual longitudinal and/or lateral control. The comfort of the driver of the vehicle can thus be increased in a particularly pronounced manner.

Alternatively or additionally, the device can be configured, on the basis of the availability information, to predict a time interval during the upcoming journey from the starting point to the destination point in which the driver will not be available for manual longitudinal and/or lateral control of the vehicle. Furthermore, the device can be configured to determine the driving route on the basis of the clearance information in such a way that the vehicle (probably) is located or will be located in the predicted time interval in a roadway section which is cleared for the automated driving mode. A driving route can thus be determined in which the one or more predicted time intervals of the nonavailability of the driver correspond and/or correlate with one or more roadway sections in which the use of the automated driving mode has clearance. In other words, the driving route can be planned in such a way that possibly a detour is taken in order to enable a higher degree of automation of the vehicle at the one or more points in time of the predicted nonavailability of the driver. The comfort of the driver of the vehicle can thus be increased reliably.

The device can be configured, on the basis of the digital map information with respect to the roadway network (and possibly in consideration of current traffic information with respect to the current traffic conditions in the roadway network), to estimate a probable duration for the driving route to be determined. The availability information can then be determined and/or predicted for the (entire) probable duration. A particularly comfortable driving route can thus be determined.

The device can be configured to determine the driving route on the basis of a routing algorithm, in which, for different possible roadway sections of the roadway network, a section weight is taken into consideration in each case, which indicates the value of the respective possible roadway section for the driving route to be determined. The section weights of the different possible roadway sections can be determined on the basis of the availability information. A section weight for a roadway section can be increased here (to indicate a relatively high value for the driving route to be planned) if the roadway section has clearance for the automated driving mode and if the roadway section is provided for a time interval along the driving route at which the driver of the vehicle is not available for the manual longitudinal and/or lateral control of the vehicle. On the other hand, a section weight for a roadway section can be reduced (to indicate a relatively low value for the driving route to be planned), if the roadway section does not have clearance for the automated driving mode and if the roadway section is provided for a time interval along the driving route at which the driver of the vehicle is not available for the manual longitudinal and/or lateral control of the vehicle. Due to the adaption of the section weights as a function of the availability information, a driving route can be determined in a particularly reliable manner which has roadway sections for automated driving which are matched particularly well to the predicted nonavailability for manual driving of the driver.

The device can be configured to determine and/or predict, upon or during the journey from the starting point to the destination point, in particular repeatedly and/or periodically, updated availability information with respect to the availability of the driver of the vehicle for manual longitudinal and/or lateral control of the vehicle during the journey from the respective current location of the vehicle to the destination point. It can thus be checked during the journey (using the originally planned driving route) whether the availability of the driver for manual longitudinal and/or lateral control of the vehicle has changed (in relation to the last forecast or prediction). For example, it can be checked whether the availability of the driver has tended to decrease. Alternatively or additionally, it can be checked whether the one or more time intervals of the availability or the nonavailability of the driver have changed.

Furthermore, the device can be configured (during the journey) to adapt the driving route from the current location of the vehicle to the destination point on the basis of the updated availability information. An updated driving route can be determined in each case here, by which a correlation measure is increased, in particular maximized. Alternatively or additionally, an updated driving route can be determined, by which the one or more roadway sections having relatively high degree of automation of the vehicle (for example having cleared automated driving mode) are adapted to the one or more updated time intervals of the nonavailability of the driver. For example, in the case of rising nonavailability of the driver, an updated driving route can be determined which has an increased proportion of roadway sections, in which the automated driving mode has clearance (and which is typically longer than the previously applicable driving route). The comfort of the driver can be increased further by a (possibly repeated) adaptation of the driving route.

The device can be configured to output route information with respect to the determined driving route to the driver of the vehicle (for example via a user interface of the vehicle). The route information can indicate (for example visually) the one or more time intervals and/or the one or more roadway sections during the journey along the determined driving route, in which the vehicle can be operated in the automated driving mode or in which the vehicle has to be operated in the manual driving mode. Due to the output of route information (with respect to one or more different planned driving routes), it can be made possible for the driver of the vehicle to search in a comfortable manner for a driving route which matches particularly well with their planned availability for manual driving.

According to a further aspect, a (road) motor vehicle (in particular a passenger vehicle or a truck or a bus) is described, which comprises the device described in this document.

According to a further aspect, a method for determining a driving route for a vehicle is described, which has an automated driving mode, in which the vehicle is longitudinally and/or laterally controlled in an at least partially automated manner, and which has a manual driving mode, in which the vehicle is longitudinally and/or laterally controlled at least partially manually by a driver of the vehicle. The method can be executed by a vehicle-internal control unit and/or by a vehicle-external unit.

The method comprises determining clearance information with respect to clearance of the automated driving mode on different roadway sections of a roadway network traveled by the vehicle. Furthermore, the method comprises determining and/or predicting availability information with respect to the availability of the driver of the vehicle for manual longitudinal and/or lateral control of the vehicle during a journey from a starting point to a destination point. The method furthermore comprises determining a driving route through the roadway network from the starting point to the destination point on the basis of the clearance information and on the basis of the availability information.

According to a further aspect, a software (SW) program is described. The SW program can be configured to be executed on a processor (for example on a controller of a vehicle or on a server), and to thus carry out the method described in this document.

According to a further aspect, a memory medium is described. The memory medium can comprise an SW program, which is configured to be executed on a processor, and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways.

The term “automated driving” can be understood in the scope of the document as driving having automated longitudinal or lateral control or autonomous driving having automated longitudinal and lateral control. Automated driving can involve, for example, driving over a longer time on the freeway or driving for a limited time in the context of parking or maneuvering. The term “automated driving” comprises automated driving with an arbitrary degree of automation. Exemplary degrees of automation are assisted, partially automated, highly automated, or fully automated driving. These degrees of automation were defined by the Bundesanstalt für Straßenwesen [German Federal Highway Research Institute] (BASt) (see BASt publication “Forschung kompakt [compact research]”, edition 11/2012). In assisted driving, the driver continuously executes the longitudinal or lateral control, while the system takes over the respective other function in certain limits. In partially automated driving (TAF), the system takes over the longitudinal and lateral control for a certain period of time and/or in specific situations, wherein the driver has to continuously monitor the system as in assisted driving. In highly automated driving (HAF), the system takes over the longitudinal and lateral control for a certain period of time without the driver having to continuously monitor the system; however, the driver has to be capable of taking over the vehicle control in a certain time. In fully automated driving (VAF), the system can automatically manage the driving in all situations for a specific application; a driver is no longer necessary for this application. The above-mentioned four degrees of automation correspond to the SAE levels 1 to 4 of the norm SAE J3016 (SAE—Society of Automotive Engineering). For example, highly automated driving (HAF) corresponds to level 3 of the norm SAE J3016. Furthermore, SAE level 5 is also provided as the highest degree of automation in SAE J3016, which is not included in the definition of the BASt. SAE level 5 corresponds to driverless driving, in which the system can automatically manage all situations like a human driver during the entire journey; a driver is generally no longer required.

The invention is described in more detail hereinafter on the basis of exemplary embodiments.

### BRIEF DESCRIPTION OF THE DRAWINGS

FIG. 1 shows exemplary components of a vehicle.

FIG. 2 shows exemplary modules for determining a user-dependent driving route.

FIG. 3 shows exemplary availability information of a user on a journey from a starting point to a destination point.

FIG. 4 shows a flow chart of an exemplary method for determining a driving route for a vehicle having an automated driving mode.

### DETAILED DESCRIPTION OF THE DRAWINGS

As described at the outset, the present document relates to determining the most comfortable possible driving route for an autonomously driving vehicle. In this context, FIG. 1 shows an exemplary vehicle 100 having an automated driving mode, which enables, for example, automated control of the vehicle 100 according to SAE level 3 or higher.

The vehicle 100 can comprise one or more environmental sensors 102, which are configured to acquire environmental data (i.e., sensor data) with respect to the environment of the vehicle 100. Exemplary environmental sensors 102 are a camera, a radar sensor, a lidar sensor, an ultrasonic sensor, etc. A control unit (or device) 101 of the vehicle 100 can be configured to create an environmental model with respect to the environment of the vehicle 100 on the basis of the environmental data. The environmental model can describe, for example, the course of the roadway, one or more other road users, one or more obstacles, etc., in the environment of the vehicle 100.

The control unit 101 can be configured to operate one or more longitudinal and/or lateral control actuators 103 (e.g., a steering device, a drive motor, a braking device, etc.) as a function of the environmental data, in particular as a function of the environmental model, in particular in order to longitudinally and/or laterally control the vehicle 100 in an at least partially automated manner (i.e., to provide an automated driving mode of the vehicle 100).

The vehicle 100 can furthermore comprise a memory unit 104, on which, for example, digital map information with respect to the roadway network traveled by the vehicle 100 is stored. Furthermore, the vehicle 100 can comprise a position sensor, for example a GPS receiver (not shown), which is configured to determine position data with respect to the position of the vehicle 100. The control unit 101 can be configured to plan a driving route for the vehicle 100 from a starting point to a destination point within the roadway network on the basis of the digital map information (possibly in consideration of the position data).

The vehicle 100 can additionally comprise a communication unit 106, which is designed to establish a (possibly wireless) communication connection 121 with a vehicle-external unit 120 (for example with a backend server). For example, updated digital map information can be provided by the vehicle-external unit 120, for example information with respect to current traffic conditions.

Alternatively or additionally, a (wireless) communication connection 111 can possibly be established with a user device 120 (for example a smart phone) of a user, in particular the driver, of the vehicle 100 via the communication unit 106 of the vehicle 100, for example to provide information with respect to the user, for example with respect to a digital calendar of the user.

Furthermore, the vehicle 100 can comprise a user interface 105 (for example having one or more operating elements and/or having one or more output elements), which enables an interaction between the vehicle 100 and the user, in particular the driver, of the vehicle 100.

Moreover, the vehicle 100 can have one or more driver sensors 107, in particular a camera directed on the driver of the vehicle 100, which are configured to acquire driver data, i.e., sensor data, with respect to the (condition of the) driver.

As described at the outset, the vehicle 100 can be designed to be operated in an automated driving mode or in a manual driving mode. The degree of automation of the vehicle 100 can possibly be settable here in multiple steps between a completely automated driving mode and a completely manual driving mode.

The degree of automation in which the vehicle 100 is operated can be dependent on the roadway section on which the vehicle 100 is located. A roadway section, for example on a freeway, can possibly have clearance for autonomous or at least partially autonomous driving. In other words, the use of the (possibly completely) automated driving mode of the vehicle can be possible on a certain roadway section. On the other hand, the use of the automated driving mode can possibly not be possible and/or the use of the manual driving mode can be required on another roadway section (for example in the city or at a construction site).

The clearance information as to whether a roadway section is fundamentally cleared for the use of the automated driving mode, and/or the clearance information about the permissible degree of automation of a vehicle 100 in a roadway section, can be stored, for example, as digital map information with respect to the roadway network traveled by the vehicle and/or provided (by the vehicle-external unit 120). The clearance information for a roadway section can possibly also be dependent here on the current weather conditions and/or on the current traffic situation and/or traffic density.

To move from a starting point to a destination point, a driving route can be planned by the control unit 101 of the vehicle 100. In the route planning, the clearance information of the roadway sections on a possible driving route can be taken into consideration. For example, a driving route can be determined which has the largest possible proportion of roadway sections on which the vehicle 100 can be operated in the automated driving mode (for example according to SAE level 3 or higher). The comfort can thus be increased for the user of the vehicle 100, since the proportion of the driving route in which the vehicle 100 has to be operated in the manual driving mode (for example according to SAE level 2 or less) can be reduced.

The control unit 101 of the vehicle 100 can be configured, for a driving route to be planned starting from a starting point to a destination point, to predict availability information with respect to the availability of the driver of the vehicle 100 during the journey from the starting point to the destination point. The availability information can be determined, for example, on the basis of
the driver data of the one or more driver sensors 107 of the vehicle 100;
data (for example calendar entries of a digital calendar) from the user device 110 of the driver; and/or
an input of the driver via the user interface 105 of the vehicle 100 (for example to reserve a time window during the journey at which manual driving is not supposed to be required).

The availability information can indicate the availability of the driver for manual vehicle control as a function of the time during the journey. The degree of availability of the driver can change with time.

For example, the driver can have a telephone conference planned in a certain time window or time interval during the journey, which has the result that the driver has a reduced availability for vehicle control in this time interval. Furthermore, the driver can have a rest phase planned in a further time interval, so that the driver is not available at all for vehicle control in this time interval. On the other hand, there can be one or more other time intervals in which the driver has no fixed plans, and is therefore probably available for the vehicle control.

The control unit 101 can be configured to take the availability information of the driver of the vehicle 100 into consideration in the planning of the driving route. In particular, a driving route can be determined which has the highest possible correspondence between
(time) intervals in which the driver is probably not available for vehicle control; and
(roadway) sections in which the vehicle 100 can be operated in the automated driving mode.

A particularly comfortable driving route for a user of a vehicle 100 can thus be determined.

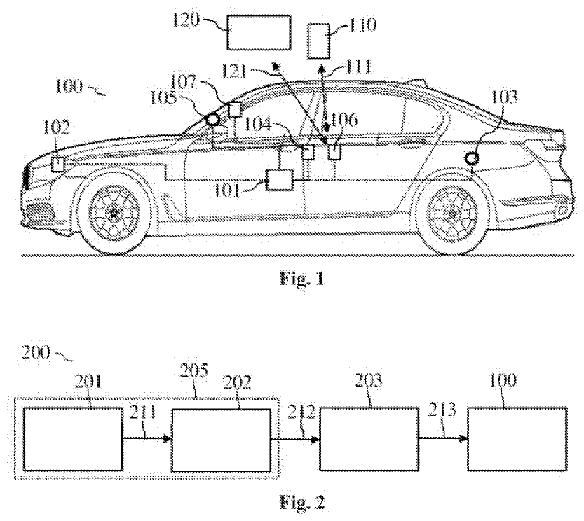

FIG. 2 shows an exemplary device 200 for determining a driving route for a vehicle 100. The device 200 comprises a behavior assessment model 201, which is designed to assess the behavior of the driver of the vehicle 100 on the journey of the driving route to be planned. The predicted behavior and/or availability information 211 can be transferred to a processing module 202, which is designed to determine, on the basis of the behavior and/or availability information 211, behavior and/or availability data 212, which have a data format that can be used in a routing algorithm. A combined module 205 can possibly be provided, which provides the behavior and/or availability data 212 directly in the data format for the routing algorithm.

The device 200 furthermore comprises a routing module 203, which is configured to determine driving route data 213 for one or more possible driving routes on the basis of the behavior and/or availability data 212 and on the basis of the digital map data (in consideration of the clearance information for the individual roadway sections).

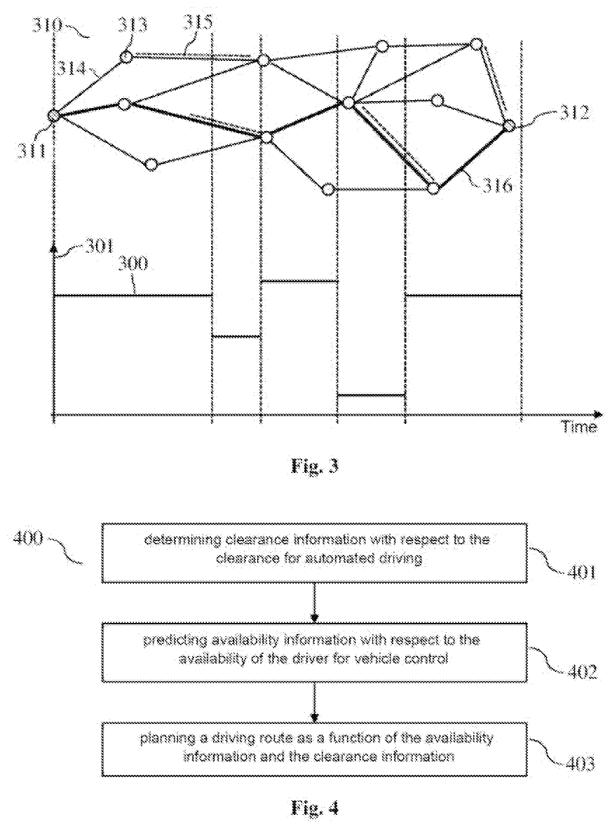

The determination of a driving route 316 starting from a starting point 311 to a destination point 312 is shown by way of example in FIG. 3. In particular, FIG. 3 shows a detail from a roadway network 310, wherein the roadway network 310 comprises a plurality of node points 313 and a plurality of edges or connecting paths 314 between different node points 313. The roadway network 310, in particular the geographic arrangement of the roadway network 310, can be indicated and/or described by the digital map information. The digital map information can furthermore indicate clearance information 315 for one or more roadway sections, i.e., for edges 314 or sections of edges 314, of the roadway network 310. In FIG. 3, the roadway sections 314, which have clearance for the use of the automated driving mode, are illustrated by dashed lines by way of example.

Furthermore, exemplary availability information 211 is shown in FIG. 3. In particular, FIG. 3 shows an exemplary time curve 300 of the availability or the degree 301 of the availability of the driver of the vehicle 100 for the manual vehicle control. The availability 301 of the driver can be taken into consideration in the route planning. In particular, a driving route 316 can be determined in which the sections having less driver availability overlap as well as possible with roadway sections 314, which have clearance for the use of the automated driving mode.

In this document, a multi-criteria route optimization with incorporation of items of road clearance information, i.e., of clearance information 315, for determining driving routes 316 is thus described. A determined driving route 316 can be adapted here with respect to one or more properties (such as estimated time of arrival (ETA), road clearance/driving clearance for assisted, partially autonomous, or fully autonomous driving, etc.) over time to observed driver behavior and/or an estimated future driver behavior wish (i.e., to availability information 211 for the driver). In particular, a driving route 316 can be determined to
increase an HAF time at a stretch, in particular maximize it; and/or
effectuate an optimization over time of the sections of the HAF time matching with one or more calendar appointments, the running entertainment program, etc. of the driver. A lengthened travel time and/or distance may possibly be accepted here.

A behavior assessor 201 can be used to assess the current and future behavior of the driver based on various data sources. The determined behavior and/or availability information 211 can be transferred to a preprocessor 202. The preprocessor 202 translates these items of information 211 into a data format usable for the routing engine 203. The assessed behavior of the driver can be divided into different time intervals (for example time buckets). Furthermore, the activities of the driver can be categorized. The different categories of the activities can be evaluated on the basis of their complexity for the driver. Activities having a relatively high complexity (and thus time intervals having a relatively low availability 301) can have a higher priority for the use of HAF time in order to optimally relieve the driver. The complexity evaluation can be based on general categories and personal items of information of the driver during comparable activities in the past (e.g., number of interventions of FAS, detected distraction from the road traffic by interior camera 107, detected appearances of fatigue, etc.). A safety-relevant, predicted behavior of the driver, such as fatigue, can receive the highest prioritization for the use of HAF (i.e., for the use of the automated driving mode). The determined data 212 can be transferred to the routing engine 203.

The routing engine 203 calculates one or more route proposals, for example, by way of a dynamic graph (as shown by way of example in FIG. 3). A route 316 can be determined in such a way that the steps of assisted and/or autonomous driving possible on the route 316 as much as possible substantially enable the planned and/or predicted activities and/or the assessed behavior of the driver. This can be enabled in particular in that link or section weights for roadway sections having positive road clearance (i.e., in which the use of the automated driving mode is possible) are increased in the time intervals (corresponding to the prioritization from the behavior assessor 201) with higher prioritization for the use of partially/fully autonomous driving (based on the assessed behavior, i.e., based on the behavior information, of the driver).

After the route calculation, it can be checked whether a calculated route 316 meets one or more secondary conditions (e.g., an estimated time of arrival (ETA) not to be exceeded at the destination point 312, a maximum permissible additional time expenditure in comparison to the fastest route, etc.).

One or more optimized routes 316 can be output to the driver via the user interface 105. Information can also be output about the one or more sections 314 of the respective route 316 in which operation in the automated driving mode takes place. The one or more routes 316 can be determined in the vehicle 100 and/or by a vehicle-external unit 120.

For example, it can be determined by comparison of the personal calendar of the user of the vehicle 100 whether an activity is planned in the time of the planned route which is easier to carry out during a TAF/HAF operation of the vehicle 100 (for example a telephone call). In a further example, the HAF time of the vehicle 100 can be adapted to the current entertainment program of the user (for example to the period of time of an audio and/or video program).

It can possibly be determined and/or learned by the proposal of multiple possible driving routes 316 whether the user accepts a longer driving time if a route 316 has more continuous HAF time and/or if a route 316 has HAF times which match well with the planned activities of the user. The route planning can thus be adapted to preferences of the user.

FIG. 4 shows a flow chart of an exemplary computer-implemented method 400 for determining a driving route 316 for a (motor) vehicle 100. The method 400 can be carried out by a control unit 101 of the vehicle 100 and/or by a vehicle-external unit 120. The vehicle 100 has an automated driving mode, in which the vehicle 100 is longitudinally and/or laterally controlled in an at least partially automated manner (for example according to SAE level 3 or more). Furthermore, the vehicle 100 has a manual driving mode, in which the vehicle 100 is longitudinally and/or laterally controlled at least partially manually by the driver of the vehicle 100 (for example according to SAE level 2, 1, or 0).

The method 400 comprises the determination 401 of clearance information 315 with respect to the clearance of the automated driving mode on different roadway sections 314 of the roadway network 310 traveled by the vehicle 100. The clearance information 315 can be provided as part of digital map information with respect to the roadway network 310. The clearance information 315 can indicate for each of the individual roadway sections 314 the possible degree of automation of vehicles 100 during the journey on the respective roadway section 314.

Furthermore, the method 400 comprises the determination and/or prediction 402 of availability information 211, 212 with respect to the availability of the driver of the vehicle 100 for manually longitudinally and/or laterally controlling the vehicle 100 during a journey from a starting point 311 to a destination point 312, wherein a driving route 316 is to be planned for the journey. The availability information 211, 212 can be determined on the basis of the sensor data from one or more driver sensors 107 of the vehicle 100 and/or on the basis of an appointment plan of the driver from a digital calendar of the driver. The availability information 211, 212 can indicate in each case for a sequence of upcoming time intervals the degree 301 of the availability of the driver for manual longitudinal and/or lateral control of the vehicle 100.

The method 400 furthermore comprises the determination 403 of a driving route 316 through the roadway network 310 from the starting point 311 to the destination point 312 on the basis of the clearance information 315 and on the basis of the availability information 211, 212. In particular, a driving route 316 can be determined in which there is the greatest possible overlap of time intervals in which the driver is not available for the manual longitudinal and/or lateral control of the vehicle 100 with roadway sections 314 in which the use of the automated driving mode is possible.

The comfort of a user of a vehicle 100 having an automated driving mode can be increased by the measures described in this document.

The present invention is not restricted to the exemplary embodiments shown. In particular, it is to be noted that the description and the figures are only to illustrate by way of example the principle of the proposed methods, devices, and systems.

1.-12. (canceled)

13. A device for determining a driving route for a vehicle having an automated driving mode in which the vehicle is longitudinally and/or laterally controlled in an at least partially automated manner, and a manual driving mode in which the vehicle is longitudinally and/or laterally controlled in an at least partially manual manner by a driver of the vehicle, the device comprising:
a processor, wherein the device is configured:
to determine clearance information with respect to a clearance of the automated driving mode on different roadway sections of a roadway network traveled by the vehicle;
to determine and/or predict availability information with respect to an availability of the driver of the vehicle for manual longitudinal and/or lateral control of the vehicle during a journey from a starting point to a destination point; and
to determine the driving route through the roadway network from the starting point to the destination point based on the clearance information and the availability information.

14. The device according to claim 13, wherein the availability information indicates, for each time interval of a sequence of time intervals during the journey from the starting point to the destination point:
a degree of the availability of the driver of the vehicle for the manual longitudinal and/or lateral control of the vehicle in the respective time interval;
a desired degree of automation of the vehicle in the respective time interval; and/or
whether the driver of the vehicle is available in the respective time interval to operate the vehicle in the manual driving mode.

15. The device according to claim 14, wherein the device is further configured:
to determine, for a possible driving route, a correlation measure of a correlation between roadway sections in which the automated driving mode is cleared, and time intervals in which the driver is not available to operate the vehicle in the manual driving mode; and
to determine the driving route such that the correlation measure is increased.

16. The device according to claim 14, wherein the device is further configured:
to determine, for a possible driving route, a correlation measure of a correlation between roadway sections in which the automated driving mode is cleared, and time intervals in which the driver is not available to operate the vehicle in the manual driving mode; and
to determine the driving route such that the correlation measure is maximized.

17. The device according to claim 14, wherein:
the clearance information indicates, for each roadway section of a plurality of roadway sections of the roadway network, a possible degree of automation of the vehicle in the respective roadway section; and
the device is further configured:
for a possible driving route having a sequence of roadway sections, to determine a correlation measure of a correlation between possible degrees of automation on the sequence of roadway sections of the possible driving route and desired degrees of automation on the sequence of time intervals during the journey from the starting point to the destination point; and
to determine the driving route such that the correlation measure is increased.

18. The device according to claim 14, wherein:
the clearance information indicates, for each roadway section of a plurality of roadway sections of the roadway network, a possible degree of automation of the vehicle in the respective roadway section; and
the device is further configured:
for a possible driving route having a sequence of roadway sections, to determine a correlation measure of a correlation between possible degrees of automation on the sequence of roadway sections of the possible driving route and desired degrees of automation on the sequence of time intervals during the journey from the starting point to the destination point; and
to determine the driving route such that the correlation measure is maximized.

19. The device according to claim 13, wherein the device is further configured:
based on the availability information, to predict a time interval during the journey from the starting point to the destination point, in which the driver will not be available for the manual longitudinal and/or lateral control of the vehicle; and
to determine the driving route based on the clearance information such that the vehicle is located in the predicted time interval in a roadway section which has clearance for the automated driving mode.

20. The device according to claim 13, wherein the device is further configured to determine and/or predict the availability information based on:
sensor data with respect to the driver, wherein the sensor data were acquired by one or more driver sensors of the vehicle;
data of an infotainment system of the vehicle;
data from a personal user device of the driver; and/or
data from a digital calendar of the driver.

21. The device according to claim 13, wherein the device is further configured to determine and/or predict the availability information based on:
sensor data with respect to the driver, wherein the sensor data were acquired by one or more interior cameras of the vehicle;
data of an infotainment system of the vehicle;
data from a personal user device of the driver; and/or
data from a digital calendar of the driver.

22. The device according to claim 13, wherein the device is further configured:
based on digital map information with respect to the roadway network, to predict a probable duration for the driving route; and
to determine and/or predict the availability information for the probable duration.

23. The device according to claim 13, wherein the device is further configured:
to determine the driving route based on a routing algorithm, in which for each possible roadway section of different possible roadway sections of the roadway network, a section weight is taken into consideration, wherein the section weight indicates a value of the respective possible roadway section for the driving route; and
to determine the section weights of the different possible roadway sections based on the availability information.

24. The device according to claim 13, wherein:
the device is further configured to output route information with respect to the determined driving route to the driver of the vehicle; and
the route information indicates one or more time intervals and/or one or more roadway sections during the journey along the driving route in which the vehicle can be operated in the automated driving mode or in which the vehicle has to be operated in the manual driving mode.

25. The device according to claim 13, wherein:
the device is further configured to determine digital map information with respect to the roadway network traveled by the vehicle, and to determine the driving route based on the digital map information; and
the digital map information comprises the clearance information for a plurality of different roadway sections of the roadway network.

26. The device according to claim 13, wherein the device is further configured, during the journey from the starting point to the destination point:
to determine and/or predict updated availability information with respect to the availability of the driver of the vehicle for the manual longitudinal and/or lateral control of the vehicle during the journey from a current location of the vehicle to the destination point; and
to adapt the driving route from the current location of the vehicle to the destination point based on the updated availability information.

27. The device according to claim 13, wherein the device is further configured, during the journey from the starting point to the destination point, repeatedly and/or periodically:
to determine and/or predict updated availability information with respect to the availability of the driver of the vehicle for the manual longitudinal and/or lateral control of the vehicle during the journey from a current location of the vehicle to the destination point; and
to adapt the driving route from the current location of the vehicle to the destination point based on the updated availability information.

28. A method for determining a driving route for a vehicle having an automated driving mode in which the vehicle is longitudinally and/or laterally controlled in an at least partially automated manner, and a manual driving mode in which the vehicle is longitudinally and/or laterally controlled at least partially manually by a driver of the vehicle, the method comprising:
determining clearance information with respect to a clearance of the automated driving mode on different roadway sections of a roadway network traveled by the vehicle;
determining and/or predicting availability information with respect to an availability of the driver of the vehicle for the manual longitudinal and/or lateral control of the vehicle during a journey from a starting point to a destination point; and
determining the driving route through the roadway network from the starting point to the destination point based on the clearance information and the availability information.
